(19) United States
(12) Patent Application Publication
(10) Pub. No.: US 2007/0140459 A1
(43) Pub. Date: Jun. 21, 2007

(54) Method for forwarding a message from a messaging server to a forwarding number

(76) Inventors: Ajay Buti, Naperville, IL (US); Sanjeev Mahajan, Naperville, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/316,088

(22) Filed: Dec. 21, 2005

(51) Int. Cl. H04M 3/42

(52) U.S. Cl. 379/211.02

(57) ABSTRACT

The present invention provides a method for forwarding a message from a messaging server. A message is received by a messaging server, which can be a voicemail system, a multimedia mail system, or the like. The messaging system determines if call forwarding is active for the subscriber who received the message. If call forwarding is active at the messaging server for the subscriber, the messaging server calls a call forwarding number stored at the messaging server. The messaging server plays the message for the call forwarding number once the call is established.

### FIELD OF THE INVENTION

The present invention relates generally to communication systems, and more particularly to call forwarding in communication systems.

### BACKGROUND OF THE INVENTION

Voice mail allows callers to leave voice messages with a mailbox associated with a called party.

Call forwarding allows a subscriber to forward calls made to a first phone number to a second phone number.

Most voicemail systems allow other voicemail users of the same voicemail system to send voicemail messages directly to the voice mailbox of another user in the voicemail system. However, when a user has forwarded call for their phone, these intra-system voicemail messages are left in the voice mailbox of the user, and the user is not aware that a message has been left.

Further, a system administrator of the voice mail system can send a broadcast message to some or all voice mailboxes at the voice mail system. Broadcast messages are typically sent without ringing or alerting the user of the message. A stuttered dial tone or light indicator may indicate that a new voicemail message is in the voice mailbox of the user, even though they have not received a new call. However, if the number has call forwarding activated, the user will not be alerted of the new voice mail message, because it did not arrive in the voice mail box via typical call alerting.

Therefore, a need exists for a method of ensuring that a user who has call forwarding activated receives all voice mail messages intended for the voice mail box associated with the forwarded number.

### BRIEF SUMMARY OF THE INVENTION

The present invention provides a method for forwarding a voice mail message by a messaging server. Instead of having a switch forward a call request to a forwarding number, an exemplary embodiment of the present invention forwards a voice mail message from a messaging server to a forwarding number. Therefore any voice mail message left with a messaging server without traversing a switch is forwarded. This can occur, for example, when a voice mail administrator sends a broadcast message to users of a messaging server or when another user of the messaging server sends a message directly to another user's mailbox on the messaging server without traversing a switch.

A messaging server, which may be a voice mail server, a video mail server, a multimedia server, or the like, receives a voice message. The messaging server determines if call forwarding is active at the messaging server. In an exemplary embodiment, the messaging server determines that call forwarding is active by determining if the directory number for the called CPE has an associated forwarding number stored within the messaging server. If there is a valid call forwarding number associated with the called number, the messaging server knows that the called number has activated call forwarding. If there is no associated call forwarding number associated with the called number, such as if the call forwarding number field is blank or includes a NULL value, the messaging server has determined that the called user does not have call forwarding activated at the messaging server.

If call forwarding is active at the messaging server, the messaging server calls the forwarding number and plays the message. If the forwarding number is not answered, the messaging server preferably plays the voice mail message in the voice mailbox associated with the called number.

In a further exemplary embodiment, the messaging server verifies that a user who answers the call is authorized to hear the voice mail message. In a first exemplary embodiment, prior to playing the voice mail message, the messaging server sends a message over the connection to the answering CPE inquiring if the person on the other end of the phone is an authorized recipient of the voice mail message. This can be accomplished via a password or voice recognition, for example. In an exemplary embodiment, the password is the same password as the password for the user to access voice mail in the account at the messaging server.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for initiating call forwarding service in accordance with an exemplary embodiment of the present invention.

FIG. 3 depicts a flowchart of a method for canceling call forwarding service in accordance with an exemplary embodiment of the present invention.

FIG. 4 depicts a flowchart of a method for forwarding a voice mail message in accordance with an exemplary embodiment of the present invention.

### DETAILED DESCRIPTION OF THE INVENTION

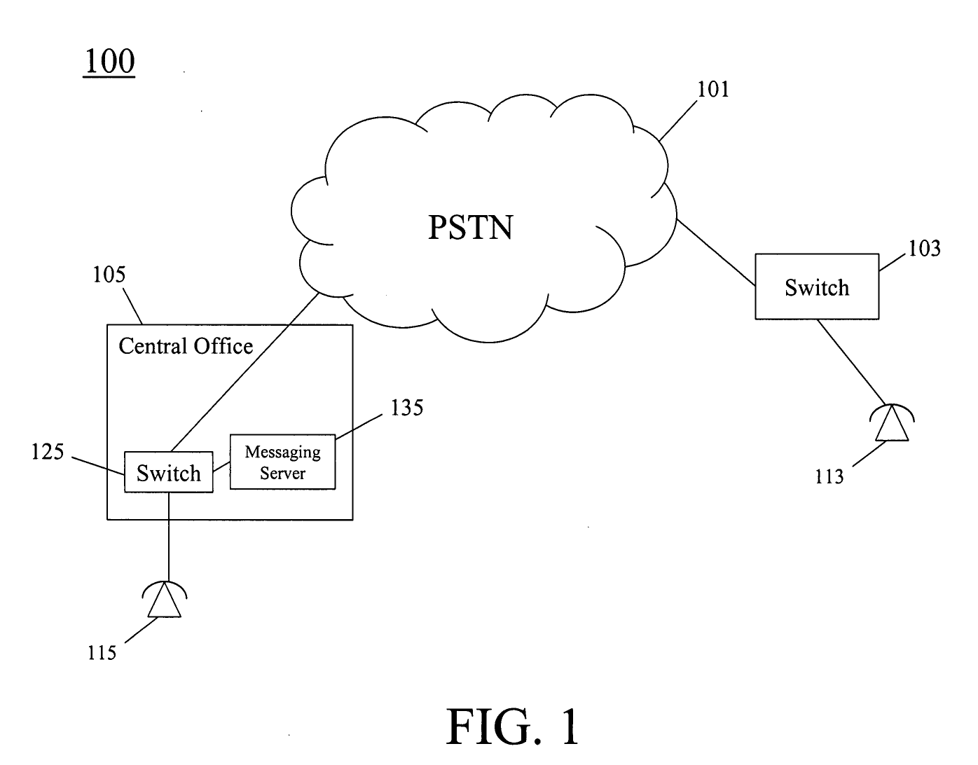

FIG. 1 depicts a communication system 100 in accordance with an exemplary embodiment of the present invention. Communication system 100 includes Public Switched Telephone Network (PSTN) 101, switch 103, and central office (CO) 105. Customer Premises Equipment (CPE) 115 is coupled to communication system 100 via central office 105 and provides the ability for users to place and receive calls within communication system 100. CPE 113 is coupled to communication system 100 via switch 103. Although communication system 100 is depicted as a wireline communication system in FIG. 1, it should be understood that the present invention can also be practiced in wireless communication system, packet-based communication system, and any other communication system that utilizes a voice mail service.

PSTN 101 is an international telephone network that provides telephony service to users connected to PSTN 101.

Switch 103 provides access for CPE 115 to communication system 100 via CO 105.

CO 105 is an office within communication system 100 to which subscriber lines, such as CPE 115, are connected on what is called a local loop. CO 105 preferably includes switching equipment that switches calls locally or to long-distance carrier phone offices. CO 115 is sometimes referred to as a public exchange.

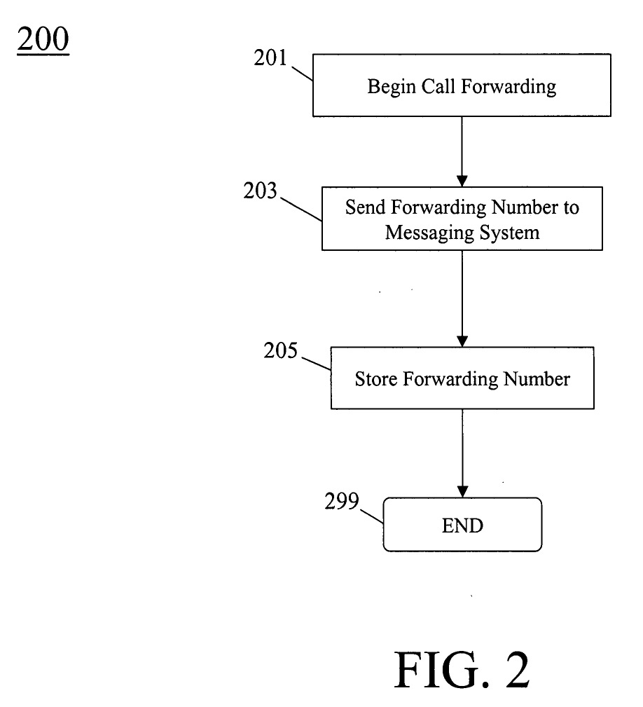

FIG. 2 depicts a flowchart 200 of a method for initiating call forwarding service in accordance with an exemplary embodiment of the present invention.

Central Office switch 125 begins (201) call forwarding. Call forwarding is preferably initiated by a user connecting to switch 125 and pressing a predefined key sequence on CPE 115 and entering a call forwarding number. Alternately, a user can access voice mail server 135 and initiate call forwarding service. In a further exemplary embodiment, a user can contact their service provider to initiate call forwarding service, for example if they are going out of town. As part of the call forwarding initiation, switch 125 identifies the directory number of CPE 115 and a forwarding number.

Switch 125 sends (203) the directory number of CPE 115 and the forwarding number to voice mail server 135.

Voice mail server 135 stores (205) the forwarding number. In an exemplary embodiment, voice mail server 135 includes a record for every voice mail subscriber. In this embodiment, if call forwarding is active, a valid call forwarding number is stored in a call forwarding field associated with the directory number of the subscriber. In an alternate exemplary embodiment, voice mail server 135 includes a record for each subscriber that currently has call forwarding activated. In either embodiment, both the directory number of the subscriber and the call forwarding number are stored by voice mail server 135.

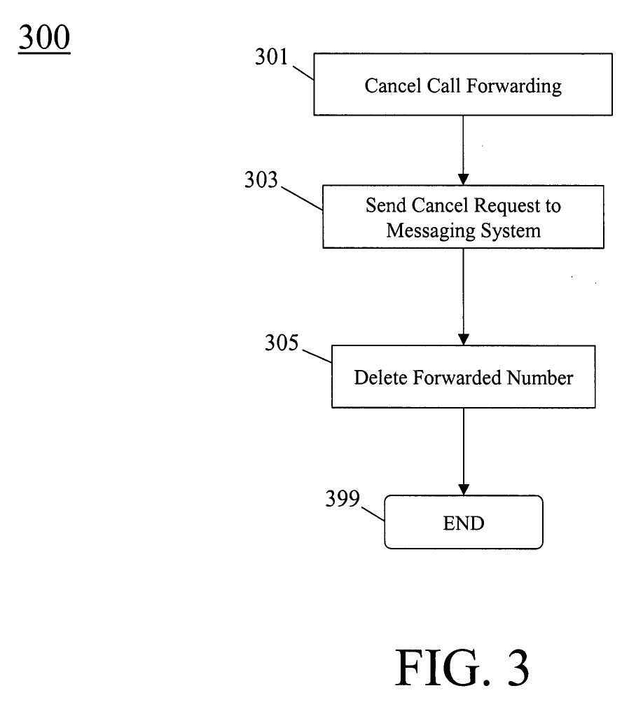

FIG. 3 depicts a flowchart 300 of a method for canceling call forwarding service in accordance with an exemplary embodiment of the present invention.

A voice mail subscriber cancels (301) the call forwarding feature. Call forwarding is preferably canceled by a user connecting to switch 125 and pressing a predefined key sequence on CPE 115. Alternately, a subscriber can access voice mail server 135 directly and cancel call forwarding service. In a further exemplary embodiment, a user can contact their service provider to cancel call forwarding service, for example when they return home after an extended period away from home or the office. As part of the call forwarding cancellation, switch 125 identifies the directory number of CPE 115.

Switch 125 sends (303) a cancel request to voice mail server 135. In accordance with an exemplary embodiment, switch 125 sends the directory number of CPE 115 in the cancel request to voice mail server 135.

Voice mail server 135 deletes (305) the forwarded number. In the exemplary embodiment in which voice mail server 135 includes a record for every voice mail subscriber, voice mail server 135 deletes the portion of the record in the call forwarding field associated with the directory number of the subscriber. For example, voice mail server 135 may overwrite the call forwarding field with a NULL value, thereby indicating that call forwarding is not active for the associated directory number. In the exemplary embodiment in which voice mail server 135 includes a record for each subscriber that currently has call forwarding activated, voice mail server 135 deletes the record associated with the directory number.

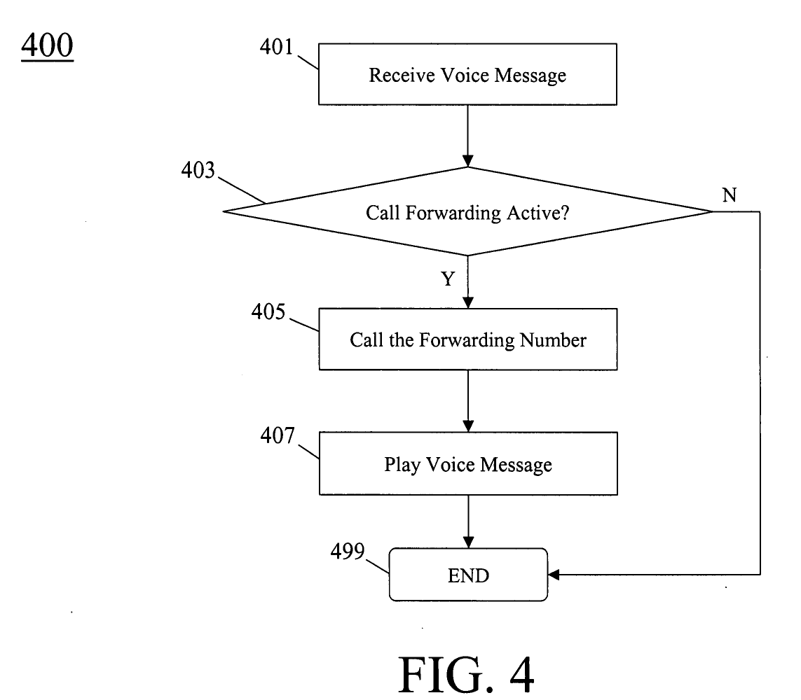

FIG. 4 depicts a flowchart 400 of a method for forwarding a voice mail message in accordance with an exemplary embodiment of the present invention. In this exemplary embodiment, the forwarding of voice mail messages is performed by voice mail server 135. Instead of having switch 125 forward a call request to a forwarding number, an exemplary embodiment of the present invention forwards a voice mail message from voice mail server 135 to the forwarding number. Any voice mail messages left with voice mail server 135 without traversing switch 125 are therefore forwarded. This can occur when a voice mail administrator sends a broadcast message to users of voice mail server 135, or by another user of voice mail server 135 who sends a message directly to another user's mailbox on voice mail server 135 without traversing switch 125.

Voice mail server 135 receives (401) a voice message. Although server 135 is called a voice mail server in this application, it should be understood that voice mail server 135 can be any type of messaging server, including but not limited to voice mail, video mail, or multimedia mail. In an exemplary embodiment, the voice message is received by voice mail server 135 when call forwarding has been activated by a user with switch 125. In an alternate exemplary embodiment, the voice message is received by voice mail server 135 when voice mail service has not been activated at switch 125.

Voice mail server 135 determines (403) if call forwarding is active. In an exemplary embodiment, voice mail server 135 determines that call forwarding is active by determining if the directory number for the called CPE has an associated forwarding number stored within voice mail server 135. If there is a valid call forwarding number associated with the called number, voice mail server knows that the called number has activated call forwarding. If there is no associated call forwarding number associated with the called number, such as if the call forwarding number field is blank or includes a NULL value, voice mail server 135 has determined that the called user does not have call forwarding activated at voice mail server 135.

If call forwarding is not active as determined in step 403, the process ends (499) and the voice mail message is processed by voice mail server 135.

If call forwarding is active as determined at step 403, voice mail server 135 calls (405) the forwarding number. Voice mail server 135 preferably establishes a connection with forwarding CPE 113. In a first exemplary embodiment, voice mail server 135 places a call to the forwarding directory number, which in this embodiment is CPE 113.

Voice mail server 135 plays (407) the voice mail message to CPE 113. In an exemplary embodiment, if CPE 113 answers the call request from voice mail server 135, voice mail server plays the voice mail message to CPE 113.

In an alternate exemplary embodiment, CPE 113 does not answer the call request from voice mail server 135. In this embodiment, voice mail server 135 preferably plays the voice mail message in the voice mailbox associated with CPE 113.

In a further exemplary embodiment, voice mail server 135 verifies that a user who answers the call of step 405 is authorized to hear the voice mail message. In a first exemplary embodiment, prior to playing the voice mail message, voice mail server 135 sends a message over the connection to CPE 113 inquiring if the person on the other end of the phone is an authorized recipient of the voice mail message. This can be accomplished via a password or voice recognition, for example. In an exemplary embodiment, the password is the same password as the password for the user to access voice mail in the account at voice mail server 135. The process then ends (499).

While this invention has been described in terms of certain examples thereof, it is not intended that it be limited to the above description, but rather only to the extent set forth in the claims that follow.

We claim:

1. A method for initiating call forwarding service at a messaging server, the method comprising:
receiving a call forwarding initiation message at a messaging server, the call forwarding initiation message including the directory number of a forwarding phone and a call forwarding number; and
storing the directory number of the forwarding phone and the call forwarding number at the messaging server.

2. A method for initiating call forwarding service at a messaging server in accordance with claim 1, wherein the step of receiving a call forwarding initiation message at a messaging server comprises receiving a predefined key sequence at the messaging server.

3. A method for initiating call forwarding service at a messaging server in accordance with claim 1, wherein the step of receiving a call forwarding initiation message at a messaging server comprises receiving a message from a service provider.

4. A method for canceling call forwarding service at a messaging server, the method comprising:
receiving a cancel message at the messaging server, the cancel message including a directory number of a forwarded phone; and
deleting at least a portion of a record associated with the directory number at the messaging server.

5. A method for canceling call forwarding service at a messaging server in accordance with claim 4, wherein the step of receiving a cancel message at the messaging server comprises receiving a predefined cancellation message at the messaging server.

6. A method for canceling call forwarding service at a messaging server in accordance with claim 4, wherein the step of receiving a cancel message at the messaging server comprises receiving a message from a service provider.

7. A method for canceling call forwarding service at a messaging server in accordance with claim 4, wherein the record comprises a directory number field and a call forwarding number field, and wherein the step of deleting at least a portion of a record associated with the directory number at the messaging server comprises overwriting the call forwarding number field with a NULL value.

8. A method for canceling call forwarding service at a messaging server in accordance with claim 4, wherein the step of deleting at least a portion of a record associated with the directory number at the messaging server comprises deleting the record associated with the directory number.

9. A method for forwarding a message from a messaging server, the method comprising:
receiving a message for a subscriber at a messaging server;
determining if call forwarding is active for the subscriber at the messaging server;
if call forwarding is active for the subscriber, calling a call forwarding number by the messaging server; and
playing the message to the call forwarding number by the messaging server.

10. A method for forwarding a message from a messaging server in accordance with claim 9, wherein the step of determining if call forwarding is active for the subscriber at the messaging server comprises determining if a directory number for the subscriber includes an associated forwarding number stored at the messaging server.

11. A method for forwarding a message from a messaging server in accordance with claim 9, the method further comprising the step of verifying that a user answering the call to the call forwarding number is authorized to hear the message.

12. A method for forwarding a message from a messaging server in accordance with claim 11, wherein the step of verifying that a user answering the call to the call forwarding number is authorized to hear the message comprises receiving a valid password from the user answering the call.

13. A method for forwarding a message from a messaging server in accordance with claim 12, wherein the valid password is the same as a password used to access a messaging account at the messaging server.

14. A method for forwarding a message from a messaging server in accordance with claim 11, wherein the step of verifying that a user answering the call to the call forwarding number is authorized to hear the message comprises utilizing voice recognition.

15. A method for forwarding a message from a messaging server in accordance with claim 9, wherein the step of receiving a message for a subscriber at a messaging server comprises receiving the message directly at the messaging server.

16. A method for forwarding a message from a messaging server in accordance with claim 15, wherein the message does not traverse a switch in a communication network.

17. A method for forwarding a message from a messaging server in accordance with claim 15, wherein the step of receiving a message for a subscriber at a messaging server comprises receiving a broadcast message at the messaging server.
